(19) United States
(12) Patent Application Publication
(10) Pub. No.: US 2024/0344171 A1
(43) Pub. Date: Oct. 17, 2024

(54) METHOD AND SYSTEM FOR PRODUCING LOW CARBON FERROCHROME FROM CHROMITE ORE AND LOW CARBON FERROCHROME PRODUCED THEREBY

(71) Applicant: MM Metals USA, LLC, West Conshohocken, PA (US)

(72) Inventors: Daniel Shaw, Haverford, PA (US); Adriaan Jacobus Van Der Merwe, Bloemfontein (ZA); Ottmar Aloys Lange, Satellite Beach, FL (US)

(21) Appl. No.: 18/756,430

(22) Filed: Jun. 27, 2024

Related U.S. Application Data
(63) Continuation-in-part of application No. 18/229,467, filed on Aug. 2, 2023.
Application No. 18/229,467 is a continuation-in-part of application No. 17/523,087, filed on Nov. 10, 2021, now Pat. No. 12,000,017.
Application No. 17/523,087 is a continuation of application No. PCT/US2020/035842, filed on Jun. 3, 2020.
Application No. PCT/US2020/035842 is a continuation of application No. 16/454,283, filed on Jun. 27, 2019, now Pat. No. 10,508,319.

(51) Int. Cl. C22B 5/04; C21D 1/74; C21D 6/00; C21D 8/12; C21D 9/00; C22B 1/24; C22C 33/04; C22C 38/18

(52) U.S. Cl. CPC C22B 5/04; C21D 1/74; C21D 6/002; C21D 8/1205; C21D 9/0025; C21D 9/0068; C22B 1/24; C22C 33/04; C22C 38/18

(57) ABSTRACT

A method and system for recovering low carbon ferrochrome from feed materials including chromite ore and aluminum granules in a chamber of an arc furnace using an aluminothermic smelting process carried out in the presence of an inert gas, e.g., Argon. The aluminothermic smelting process produces a bath of molten low carbon ferrochrome metal with molten slag floating thereon in the chamber. The molten low carbon ferrochrome metal and molten slag are extracted individually and processed to provide a solidified low carbon ferrochrome metal product and a solidified slag particles product, respectively. A method for the recirculation, recovery and reuse of the inert gas, and a system for accomplishing the recirculation, recovery and reuse of the inert gas.

### CROSS-REFERENCE TO RELATED APPLICATIONS

This application is a Continuation-In-Part of U.S. patent application Ser. No. 18/229,467, filed on Aug. 2, 2023, entitled METHOD AND SYSTEM FOR PRODUCING LOW CARBON FERROCHROME FROM CHROMITE ORE AND LOW CARBON FERROCHROME PRODUCED THEREBY, which in turn is a Continuation-In-Part of U.S. patent application Ser. No. 17/523,087, filed on Nov. 10, 2021, entitled METHOD AND SYSTEM FOR PRODUCING LOW CARBON FERROCHROME FROM CHROMITE ORE, which in turn is a Continuation of PCT/US2020/035842, filed on Jun. 3, 2020, entitled METHOD AND SYSTEM FOR PRODUCING LOW CARBON FERROCHROME FROM CHROMITE ORE AND LOW CARBON FERROCHROME PRODUCED THEREBY, and which claims the benefit under 35 U.S.C. § 120 of U.S. patent application Ser. No. 16/454,283, filed on Jun. 27, 2019, entitled METHOD AND SYSTEM FOR PRODUCING LOW CARBON FERROCHROME FROM CHROMITE ORE AND LOW CARBON FERROCHROME PRODUCED THEREBY, now U.S. Pat. No. 10,508,319, issued on Dec. 17, 2019, the disclosures of all of which applications are incorporated by reference herein.

### FIELD OF THE INVENTION

This invention relates generally to alloy forming and more particularly to methods and systems for producing low carbon ferrochrome from chromite ore and low carbon ferrochrome produced thereby.

### SPECIFICATION

### Background of the Invention

Low carbon ferrochrome (“LC FeCr”) is a niche product having several uses, the most common of which being for “trimming adjustment” of high chromium content steels in ladle furnaces where introduction of carbon from high carbon ferrochrome is unacceptable. There are several grades of LC FeCr with varying amounts of carbon, silicon and nitrogen and which are produced from chromite ores. LC FeCr may be manufactured from chromite ore by several processes such as the Perrin process and the Duplex process, the Simplex process, etc., all of which use silicon as reductant in the form of ferro silicon (FeSi) and silicon metal (SiMet). Aluminum has been used as an alternative reducing agent instead of using silicon. By using aluminum as the reducing agent, instead of using carbon, it is possible to produce the metal alloy low carbon ferrochrome which contains about 70% chromium. However, the conventional carbon reductant smelting processes for producing LC FeCr from chromite leave much to be desired from the standpoints of economic and environmental protection.

Thus, a need exists for a system and method of producing low carbon ferrochrome from chromite ore which can be carried out economically and is environmentally friendly. The subject invention addresses that need.

### BRIEF SUMMARY OF THE INVENTION

One aspect of this invention is a system for recovering ferrochrome metal or another ferroalloy in a chamber of an arc furnace using an aluminothermic smelting process, wherein the aluminothermic smelting process is carried out in the presence of an inert gas introduced into the chamber, whereupon a furnace off-gas including the inert gas and particles of dust is produced during the smelting process. The system comprises a main inert gas supply tank, an off-gas duct, a primary damper, a dust removing cyclone apparatus, a heat exchanger, a buffer tank, an induced draft gas draw fan, a pressurized tank, and a gas compressor. The off-gas duct is configured to be coupled to the arc furnace and forms an upstream component of a gas flow path from the arc furnace, whereupon the furnace off-gas is delivered by the off-gas duct into a gas flow path. The primary damper is located in the gas flow path downstream of the off-gas duct and is coupled to a vent in communication with the ambient atmosphere. The dust-removing cyclone apparatus is located in the gas flow path downstream of the primary damper and configured for cooling the furnace off-gas from the primary damper and for removing particles of dust from the furnace off-gas. The heat exchanger is located in the gas flow path downstream of the dust-removing cyclone apparatus for further cooling the furnace off-gas from the dust-removing cyclone apparatus to produce cooled furnace off-gas. The buffer tank has an interior at atmospheric pressure and an outlet coupled to the interior of the buffer tank and is located in the gas flow path downstream of the heat exchanger for receipt of the cooled furnace off-gas from the heat exchanger. The induced draft gas draw fan is located in the gas flow path between the heat exchanger and the buffer tank for drawing the cooled furnace off-gas from the heat exchanger and providing it into the interior of the buffer tank, whereupon the inert gas drops to a bottom portion of the interior of the buffer tank and out of the outlet. The pressurized tank is located in the gas flow path downstream of the buffer tank. The gas compressor is located in the gas flow path between the outlet of the buffer tank and the inlet to the pressurized tank and is configured for compressing the cooled furnace gas from the outlet of the buffer tank to a desired pressure to produce compressed cooled furnace gas and delivering the compressed cooled furnace gas to the pressurized tank. The pressurized tank is coupled to the main inert gas supply tank for receipt of inert gas from the main inert gas supply tank, whereupon the inert gas tops off the compressed cooled furnace gas in the pressurized tank to produce pressurized recycled inert gas. The pressurized tank is coupled to the arc furnace to deliver the pressurized recycled inert gas from the pressurized tank back to the arc furnace.

In accordance with one preferred aspect of the system of this invention the inert gas is Argon and wherein the system additionally comprises a source of feed materials comprising chromite ore, aluminum granules and burnt lime, the feed materials being fed into the chamber along with the Argon gas.

In accordance with another preferred aspect of the system of this invention the off-gas duct is water-cooled.

In accordance with another preferred aspect of the system of this invention the dust-removing cyclone apparatus is water-cooled.

In accordance with another preferred aspect of the system of this invention the primary damper is configured to control the furnace freeboard pressure by restricting gas flow downstream of the furnace, and to prevent complete gas flow downstream of the furnace to the dust-removing cyclone apparatus.

In accordance with another preferred aspect of the system of this invention the heat exchanger is a pipe cooler.

In accordance with another preferred aspect of the system of this invention the gas compressor is a screw-type gas compressor.

In accordance with another preferred aspect of the system of this invention the buffer tank includes a pressure relief vent to the ambient atmosphere.

In accordance with another preferred aspect of the system of this invention the system additionally comprises a primary gas analyzer located in the gas flow path between the off-gas duct and the primary damper.

In accordance with another preferred aspect of the system of this invention the system additionally comprises a secondary gas analyzer located in the gas flow path between the pressurized tank and the arc furnace In accordance with another preferred aspect of the system of this invention the system additionally comprises a secondary flow damper located in the flow path between the heat exchanger and the induced draft gas draw fan, the secondary flow damper being configured to control the pressure drop over the dust-removing cyclone apparatus and heat exchanger.

Another aspect of this invention is a method of recovering ferrochrome metal or another ferroalloy in a chamber of an arc furnace using an aluminothermic smelting process, wherein the aluminothermic smelting process is carried out in the presence of an inert gas introduced into the chamber along with feed materials, whereupon a furnace off-gas including the inert gas and particles of dust is produced within the chamber. The method comprises removing the furnace off-gas from the chamber and cooling the furnace off-gas in an off-gas duct forming a portion of a gas flow path from the chamber of the arc furnace. A first apparatus is provided in the flow path downstream of the off-gas duct for further cooling of the furnace off-gas and removing particles of dust from the furnace off-gas to result in low particle furnace off-gas. A second apparatus is provided in the gas flow path downstream of the first apparatus for cooling the low particle furnace off-gas to produce cooled low particle furnace off-gas. The cooled low particle furnace off-gas is carried into an interior of a buffer tank at atmospheric pressure, whereupon the cooled low particle furnace off-gas drops to a bottom portion of the interior of the buffer tank. The cooled low particle furnace off-gas from the interior of the buffer tank is compressed to produce pressurized low particle cooled furnace off-gas and the pressurized low particle cooled furnace off-gas is provided to a pressurized tank in the gas flow path downstream of the buffer tank. The pressurized low particle cooled furnace off-gas is provided from the pressurized tank back to the arc furnace.

In accordance with one preferred aspect of the method of this invention the method additionally comprises providing a main inert gas supply tank holding inert gas, coupling the main inert gas supply to the pressurized tank to deliver the inert gas from the main inert gas supply tank to the pressurized tank, whereupon the inert gas tops off the pressurized low particle cooled furnace off-gas in the pressurized tank to produce pressurized recycled inert gas, and delivering the pressurized recycled inert gas from the pressurized tank back to the arc furnace.

In accordance with one preferred aspect of the method of this invention, the method additionally comprises providing a primary damper located in the gas flow path downstream of the off-gas duct to cause control of the furnace freeboard pressure by restricting the gas flow downstream of the furnace, and to prevent complete gas flow downstream of the furnace to the dust-removing cyclone apparatus.

In accordance with another preferred aspect of the method of this invention, the inert gas is Argon, and wherein the feed materials comprise chromite ore, aluminum granules and burnt lime.

In accordance with one preferred aspect of the method of this invention, the feed materials are fed into the chamber with the Argon

### BRIEF DESCRIPTION OF SEVERAL VIEWS OF THE DRAWINGS

FIG. 1A is an illustrative diagram showing a portion of one exemplary embodiment of a smelting system constructed in accordance with this invention for carrying out the methods of this invention to produce low carbon ferrochrome and a recoverable slag from chromite and other feed materials, which other feed materials contain aluminum in aluminum granules, e.g., granules produced from scrap aluminum, as the reductant, and burnt lime powder, as the flux, with the portion of the system for producing low carbon ferrochrome as shown in FIG. 1A including a particulates/solids transport subsystem for processing particulates/solid materials and showing the paths of such particulates/solids through the system;

FIG. 1B is another illustrative diagram showing the other portion of the exemplary system shown in FIG. 1A, e.g., a gas transport subsystem for handling of gases used in the system and the paths of such gases through the system.

FIG. 2 is an illustration of one portion of a system for producing one of the feed materials used in the system and method of this invention, i.e., the chromite ore;

FIG. 3 is an illustration, like that of FIG. 2, showing another portion of a system for producing another of the feed materials used in the system and method, i.e., the burnt lime, forming the recoverable slag produced by the system and method;

FIG. 4 is an illustration, like that of FIGS. 2-3, showing another portion of a system for producing another of the feed materials used in the system and method, i.e., the recycled solids forming the recoverable slag produced by the system and method;

FIG. 5 is an illustration, like that of FIGS. 2-4 showing another portion of system for producing the last of the feed materials used in the system and method, i.e., the scrap aluminum granules;

FIG. 6 is vertical sectional view of one exemplary DC plasma arc furnace forming a portion of the system of this invention and suitable for use in the methods of this invention;

FIG. 7 is an enlarged sectional view taken along line 7-7 of FIG. 6 (i.e., a top plan view of the furnace);

FIG. 8 is an isometric drawing illustration of the arc furnace shown in FIG. 6 during the stirring of the molten material bath in the furnace;

FIG. 9 is an enlarged cross-sectional view of a portion of the furnace, e.g., the molten slag taphole shown within the broken line circle designated by the reference number 9 in FIG. 6;

FIG. 10 is an enlarged cross-sectional view of another portion of the furnace, e.g., the LC FeCr taphole shown within the broken line circle designated by the reference number 10 in FIG. 6; and

FIG. 11 is an illustrative diagram showing a preferred embodiment of an inert gas (e.g., Argon) recirculation and recovery system for providing and recirculating inert gas (e.g., Argon) used in the smelting system and process shown in FIG. 1A-10 and for introducing fresh top-up inert (e.g., Argon) gas from a main inert (e.g., Argon) gas supply tank to the recirculation and recovery system.

### DETAILED DESCRIPTION OF ONE EXEMPLARY

### Preferred Embodiment of the Invention

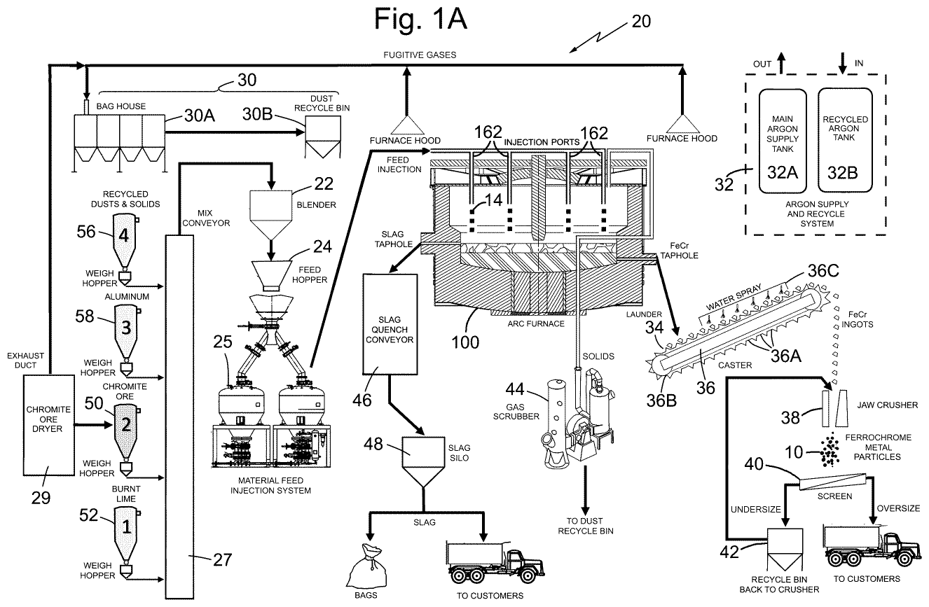

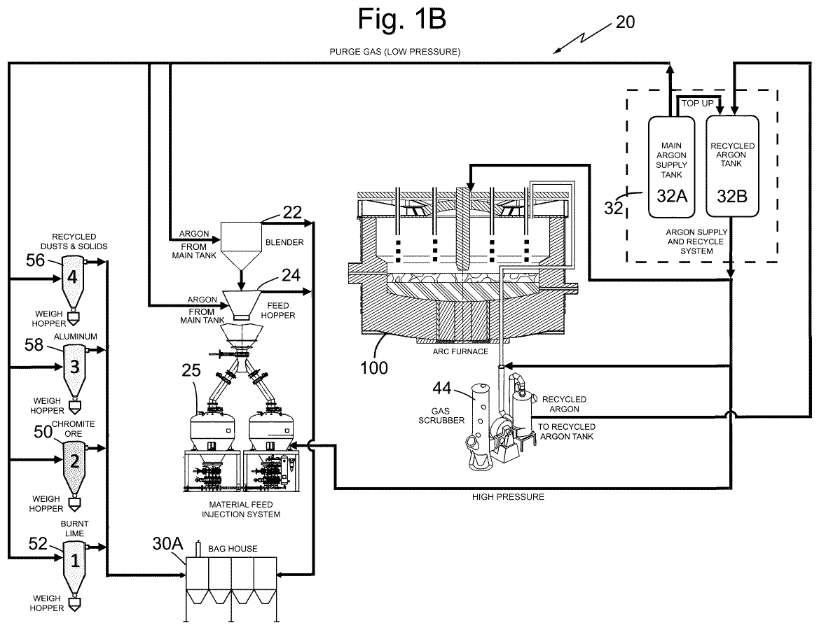

Referring now to the various figures of the drawing wherein like reference characters refer to like parts, there is shown in FIG. 1 one exemplary smelting system 20 constructed in accordance with this invention for carrying out a method or process of this invention to produce low carbon ferrochrome ingots (referred to hereinafter as “ferrochrome product ingots”), and slag particles (referred to hereinafter as “slag product particles”) on a commercial scale using an aluminothermic process or technique (to be described in detail later). Following the crushing of the ferrochrome product ingots, into smaller pieces, these pieces are then suitable for various uses, e.g., the “trimming adjustment” of high chromium content steels in ladle furnaces. The quenched slag product particles are suitable for various uses, e.g., the making of cement and concrete.

Before describing the details of the system 20 and the methods of this invention it must be noted that any mention of other potential exemplary embodiments of such systems and methods as may be found in this application are being provided so that this disclosure will be thorough and will fully convey the scope of the invention to those who are skilled in the art. Numerous specific details are set forth hereinafter, such as examples of specific components, devices, and methods, to provide a thorough understanding of the present disclosure. It will be apparent to those skilled in the art that specific details need not be employed, that the exemplary system 20 as will be described later may be embodied in many different forms and that neither should be construed to limit the scope of the disclosure. In some cases, well-known processes, well-known device structures, and well-known technologies are not described in detail.

It should also be noted that the terminology used herein is for the purpose of describing the particular exemplary system 20 only and is not intended to be limiting. Moreover, as used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments. Spatially relative terms, such as “inner,” “outer,” “beneath” “below” “lower” “above” “upper” and the like may be used herein for ease of description to′ describe one element or feature's relationship to another element(s) or feature(s) as illustrated in the figures. Spatially relative terms may be intended to encompass different orientations of the device in use or operation in addition to the orientation depicted in the figures. For example, if any component or structure shown in the figures is turned over, elements described as “below” or “beneath” other elements or features would then be oriented “above” the other elements or features. Thus, the example term “below” can encompass both an orientation of above and below.

The method/process of this invention basically entails feeding a mixture of feed materials comprising aluminum granules, burnt lime, and chromite ore into a direct current (DC) plasma arc furnace. The aluminum granules are produced from scrap aluminum grades that are low in magnesium and copper contents. The major oxides contained in the chromite ore are chromium oxide, iron oxides (FeO and Fe₂O₃), aluminum oxide, magnesium oxide, and silicon oxide. The feed materials are provided in a proportion determined through thermochemical calculations for reduction of the chromium oxide and iron oxides to form low carbon ferrochrome. The feeding of the feed mix materials into the DC plasma arc furnace is controlled in accordance with the active power input to the DC plasma arc furnace. The feed materials are injected into the plasma arc furnace containing molten ferrochrome and molten slag, wherein the aluminum in the aluminum granules acts as a reducing agent to produce an exothermic reaction, reducing the chromium oxide and iron oxides in the chromite ore to produce molten low carbon ferrochrome with molten slag, floating on top of the molten low carbon ferrochrome, due to density differences. The molten low carbon ferrochrome is intermittently tapped from the DC plasma arc furnace, whereas the slag is continuously tapped.

Preferably the method entails the continuous tapping of the molten slag from the DC plasma arc furnace and water quenching the tapped molten slag into quenched particles of slag. Also preferably, Argon gas under pressure higher than atmospheric pressure is provided into the DC plasma arc furnace to prevent air ingress into the plasma arc furnace and thus oxygen from entering the DC plasma arc furnace and to inject the raw feed mix input materials.

Turning now to FIGS. 1A and 1B, it can be seen that the system 20 basically comprises a feed mix materials blender 22, a blended feed mix day bin 24, a feed mix injection system 25, a direct current (DC) plasma arc furnace 100, a gas cleaning and recirculation system 30, an Argon supply and recycle system 32, a hot metal launder 34, a metal ingot caster 36, a metal ingot crusher 38, a screen 40, a ferrochrome particles recycling bin 42, a gas scrubber 44, a slag quench conveyor 46, and a quenched slag particles product collecting bin 48. The details of the construction and operation of those components will be described later. Suffice for now to state that the blender 22 is configured to receive the feed materials for producing low carbon ferrochrome metal product pieces and the quenched slag particles, each of which constitute valuable a product. The feed materials for the process are chromite ore 50, lime (e.g., burnt lime) 52, miscellaneous feed materials 54, recycled furnace off-gas dust/solid materials 56, and aluminum granules 58. The aluminum granules are produced on site from scrap aluminum or can be produced off-site from any type of aluminum scrap. Examples of such aluminum scrap are Mixed Low Copper scrap packages (for example scrap types 6000, 3000, 1000, 5000 series of scrap).

The feed materials are provided from respective feed bins to the blender 22 in a desired and controlled proportion to one another. Each of the feed material supply bins have a conventional level indicator (not shown) with an associated conventional and controllable Argon pneumatic transfer weigh hopper (not shown) to provide the desired amount of the individual feed materials to the blender 22. The Argon gas for the pneumatic transfer weigh hoppers is provided from the Argon supply and recycle system 32. That system basically comprises a Main Argon Supply Tank 32A and a Recycled Argon Supply Tank 32B and associated conduits (not shown). As best seen in FIG. 1B the Argon gas for the pneumatic transfer weigh hoppers is provided from Main Argon Supply Tank 32A. The transportation of the feed materials from their respective supply bins to the feed mix material blender 22 is achieved by means of a mix conveyer 27, which comprises a feed Collection Vibratory Conveyor and which is available from General Kinematics. The blender 22 is purged with Argon gas from the main supply tank 32A.

The chromite ore is dried in a dryer 29 before being supplied to the chromite ore feed bin 50. The dryer 29 basically comprises an Indirect Gas Fired Tube Dryer and which is available from L Haberny Company. Off-gases, dust and other particulates produced by the heating of the chromite ore in the dryer exit through an exhaust duct and are carried by conduits to the gas cleaning and recirculating system 30. That system basically comprises a bag house 30A and a dust recycle bin 30B.

The blender is a conventional device (e.g., like that available from Kelly Duplex Mill & Manufacturing Co.) and is configured to mix the feed materials together and provide the mixed feed materials to the blended feed day bin 24. The blender is supplied with Argon gas (purged at low volumetric flow rate) to displace air (oxygen and nitrogen) entrained in the feed materials. The blended feed day bin 24 is a conventional device (e.g., like that available from Coperion K-Tron) and is configured to store the feed mix materials and feed them at a controlled rate into the dispensing vessels of feed mix materials injection system 25. To that end, a weigh scale (not shown) is used with the blended feed day bin so that the amount of feed materials fed to the furnace 100 can be controlled by a controller (not shown). When the mix of feed materials, now designated by the reference number 14, is injected into the furnace 100 from a feed injection line and the furnace is operated the aluminum granules act as a reducing agent to produce an exothermic reaction reducing the oxygen in chromium oxide and iron oxides of the chromite ore to produce molten low carbon ferrochrome metal with molten slag floating on top of the molten low carbon ferrochrome metal. The molten slag produced by the exothermic reaction of the aluminum with the chromite ore results in aluminum oxide reporting to the slag, with negligible amounts of aluminum reporting to the low carbon ferrochrome metal.

As mentioned above the subject invention entails the production of low carbon ferrochrome by an aluminothermic process or technique, i.e., aluminothermic reduction (ATR). In particular, the reduction reaction proceeds as per the following reaction equation:

$$\frac{2}{3} 〈 {Cr}_{2} {O}_{3} 〉 + \frac{4}{3} 〈 Al 〉 = \frac{4}{3} 〈 Cr 〉 + \frac{2}{3} 〈 {Al}_{2} {O}_{3} 〉$$

$$Δ G ° = - 309 + 0.004 T kJ$$

The amount of heat generated per unit mass of the reactants for the aforesaid reaction is 2649 kJ/kg. It is sufficiently higher than that required by other known low carbon ferrochrome processes. As is known ATR is a more effective and easier process as compared to silicothermic reduction. High refractory slag (Al₂O₃+Cr₂O₃) having high melting point can be kept fluid by making use of a flux, such as burnt lime (CaO content >95%) in the charge input mix. This will improve the recovery of low carbon ferrochrome metal. Excess use of pyrophoric aluminium should be avoided. Thermodynamic calculations on the above reaction and input mix of 70% chromite ore, 20% aluminium granules and 10% burnt lime flux, at 1800° C., predict a split between low carbon ferrochrome metal and slag of 29.5% metal and 70.5% slag, respectively.

In accordance with one preferred aspect of this invention, the amount of aluminum granules used in the mixture of feed mix materials is determined through thermochemical calculations to maximize the amount of chromium oxide that is reduced from a given chromite ore, thus maximizing the amount of chromium in the ferrochrome, whilst minimizing the amount of silicon and aluminum in the ferrochrome. Moreover, it is preferably that the process is a continuous process with the feed rate of the feed mix materials or reactants and the power supply input of the plasma electrode in the plasma arc furnace being controlled by the power-to-feed ratio controller (not shown) to ensure that the molten phase will not cool down excessively if the feed rate of the feed materials is altered to alter the rate of exothermic reaction.

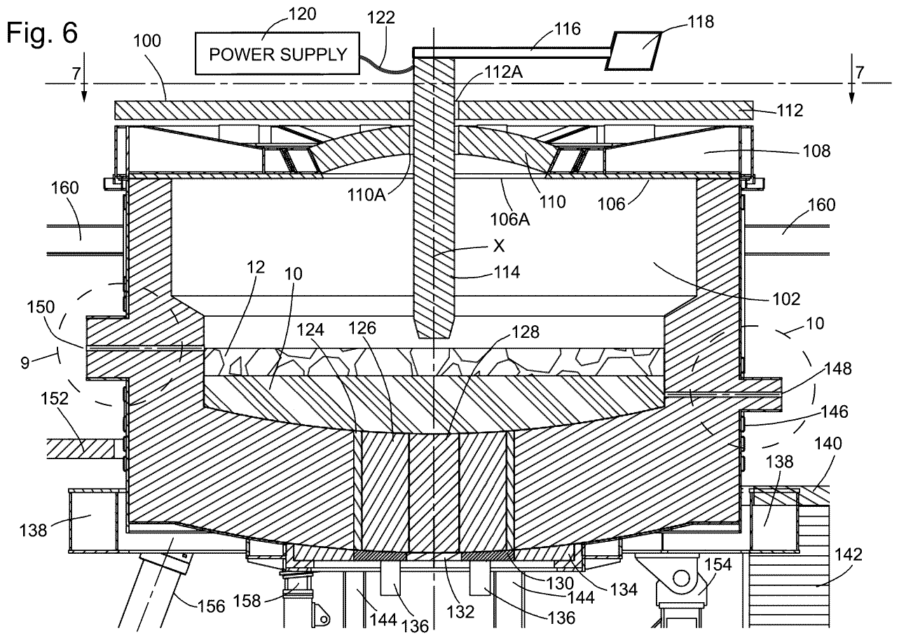

In the exemplary embodiment of system 20 shown in FIGS. 1A and 1B, the DC plasma arc furnace 100 is an electric arc furnace constructed in accordance with one aspect of this invention. FIG. 6 is a somewhat simplified vertical sectional view of the furnace 100. The furnace 100 includes a chamber 102 into which the feed materials are fed and where the exothermic reaction takes place to result in the reduction of the chromium oxide and the iron oxides in the chromite ore by the aluminum in the aluminum granules. The chamber is formed by between a roof and the walls and base of a conductive thermal refractory housing or body 104. Preferably the housing is made up of a suitable high temperature resistant and chemical attack resistant refractory lining to ensure the integrity of the DC plasma arc furnace and containment of the molten metal and slag materials in the furnace.

The top or roof of the furnace is composed of a refractory roof liner 106, roof panels 108, a central dome 110 and a roof platform 112. The liner 106 is a planar body formed of high alumina (Al₂O₃)-chrome oxide (Cr₂O₃) refractory and closes off the top of the chamber 102 except for a central opening 106A in the liner. The roof panels 108 are in the form of hollow ductwork formed of high alumina (Al₂O₃)-chrome oxide (Cr₂O₃) castable and are disposed above the liner 106. The roof panels 108 have a central opening 108A corresponding generally is size and shape to the central opening in the liner in which the central dome 110 is located. The central dome is formed of high alumina (Al₂O₃)-chrome oxide (Cr₂O₃) bricks and includes a central opening 110A. The roof platform 112 is disposed over the roof panels 108 and the central dome 110 and is a planar body formed of grated steel. The roof platform includes a central opening 112A. The central opening 112A is configured to closely receive a portion of an elongated cathode electrode 114 extending therethrough, whereupon a slight gap results between the outer surface of the portion of the cathode electrode and the inner surface of the opening 112A.

The cathode anode described in detail later. Suffice it for now to state that it is a cylindrical member that extends along the vertically oriented longitudinally extending central axis X of the furnace. The central opening 110A in the central dome is also configured to closely receive a portion of an elongated cathode electrode 114 extending therethrough, whereupon a slight gap results between the outer surface of the portion of the cathode electrode and the inner surface of the opening 110A. The cathode electrode is supported and held extending into the chamber by an arm 116 coupled to an electrode regulation system 118 which is configured to raise and lower the electrode along the axis X with respect to the bottom of the chamber, whereupon the spacing between the bottom of the cathode electrode and the bottom of the chamber can be adjusted as desired, and as will be explained later. The cathode electrode 114 is electrically connected to an electrical power source via a flexible copper bus 122. The electrical power source includes a rectifier having a negative pole to which one end of the bus 122 is electrically connected. The opposite end of the bus 122 is electrically connected to the upper end portion of the cathode electrode.

The bottom portion of the chamber 102 forms what can be called the furnace's hearth, where a bath of molten low carbon ferrochrome with a layer of slag floating on top thereof result from the operation of the arc furnace 100. The layer of molten low carbon ferrochrome is located at the bottom of the chamber 102 and is designated by the reference number 10, with the layer of slag floating thereon being designated by the reference number 12.

The central portion of the bottom of the refractory housing or body 104 includes an electrical isolation cylindrical sleeve 124 formed of high alumina (Al₂O₃) ramming material surrounding an annulus 126 of an electrically conductive hearth refractory material. The annulus 126 in turn surrounds a column 128 of an electrically non-conductive hearth refractory. An electrical return water-cooled anode disc 130 formed of copper is disposed under and in engagement with the undersurface of the sleeve 124 and the undersurface of the electrically conductive annulus 126, so that it is in electrical engagement with the annulus 126 but electrically isolated from the conductive refractory body making up the base of the housing. The anode disc 130 includes a central opening in which a support disc 132 is located. The support disc is formed of steel is in engagement with the undersurface of the electrically non-conductive hearth refractory column 128. The anode 130 is held in place under the bottom of the furnace's housing or body 104 by a steel support member 134. Electrical power for the anode is provided by electrically conductive bus bar bolting flanges 136 formed of copper. The electrical power for the anode is provided from the power source 120 via electrical connectors (not shown) to the bus bar bolting flanges 136.

The furnace's housing or body 104 is itself supported on the floor of the building in which it is located by a support frame 138. Disposed under the furnace are forced air cooling ducts 144 which extend to the hearth region of the furnace to cool it. Moreover, a cooling shell 146, including water cooling channels, extends about the lower portion of the housing to cool the hearth region.

Two tapholes 148 and 150 are provided in the furnace's housing to tap the molten low carbon ferrochrome and the molten slag from the furnace's chamber. The taphole 148 forms taphole from which the molten low carbon ferrochrome 10 is tapped to exit the furnace and thus is at the elevation with respect to the chamber 102 where the bath of molten low carbon ferrochrome will be produced. The taphole 150 forms the taphole from which the molten slag 12 is tapped to exit the furnace and thus is at the elevation with respect to the chamber 102 where the bath of molten slag will be produced, whereupon the molten slag taphole 150 is located above the height of the molten low carbon ferrochrome taphole 148.

A platform extends about the lower portion of the housing of the furnace, with a portion 140 located adjacent the molten low carbon ferrochrome taphole 148 to provide service personnel access to portions of the housing and the molten low carbon ferrochrome taphole 148. A flight of stairs 142 extends to the platform from the ground or other surface of the building in which the furnace is located. The platform includes another portion 152 to provide those service personnel access to other portions of the housing and to the molten slag taphole 150.

The furnace is configured to be tilted from its normal vertically oriented operating position or state, like shown in FIG. 6, to a tilted state (not shown) at which the central longitudinal axis X of the furnace extends at an acute angle, e.g., up to a maximum of approximately 7°, with respect to a vertical axis. The tiltability of the furnace to the tilted state is provided so that flow of the molten low carbon ferrochrome and the molten slag to their respective tapholes can be expedited when desired or necessary, e.g., allowing controlled emptying of the furnace contents in case of an emergency and controlled emptying of slag when slag content in the furnace is at a level higher than the slag taphole. To that end, the furnace includes a furnace tilting pivot column 154 and a furnace tilting cylinder 156 each of which are coupled to the support frame 138. The pivot column 154 forms the fixed point about which the furnace can be tilted by the operation of the furnace tilting cylinder 156. A locking device 158 in the form of a hydraulically operated pin is provided to lock the furnace in its normal vertically oriented operating position.

Rails 160 are provided on the housing for holding taphole equipment, such as drills, mudguns and other tools for opening and closing the tapholes 148 and 150.

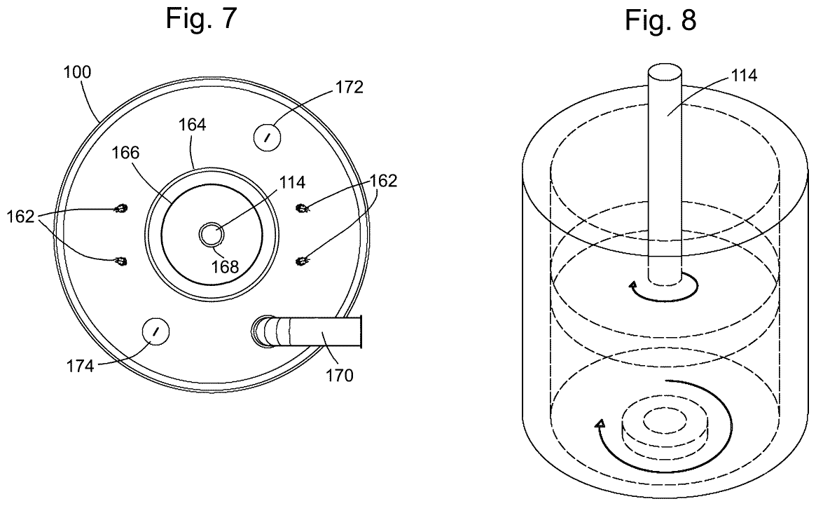

Turning to FIG. 7 the construction of the top portion of the furnace will now be described. As can be seen, the furnace includes four feed mix injection ports 162, a roof panel water cooled support ring 164, a roof dome water cooled support ring 166, an electrode port with electrode gas seal 168, a furnace gas exit porting 170, an inspection port with hatch 172, and a sampling/sounding port with hatch 174. The injection ports carry the feed material mix 14 from the material feed injection system 25 into the interior of the chamber 102 at the top portion thereof. The inspection port with hatch 172 provides access to the interior of the chamber 102 for inspection thereof by operating/service personnel. The sampling/sounding port with hatch 174 provides access to the interior of the chamber for depth measurements.

The roof panel water-cooled support ring 164 basically comprises a mild steel closed channel and serves to support the roof panels where these attach to the water-cooled roof ring and it supports the dome bricks forming the dome. The interface between the water-cooled support ring 164 and the first ring of the bricks that form the dome is designated by the reference number 166. To enable the free movement of the electrode 114 a gap 168 is provided between the outer surface of the electrode and the inner surface of the last ring of the dome bricks. The gap 168 is aligned with the central opening 112A in the roof platform 112.

In operation the chamber 102 is filled with Argon gas which is used as the carrier gas to inject the feed mix materials 14 into the chamber via the four feed mix injection ports 162. In addition, an inert gas purge e.g., Argon gas under positive pressure of at least 0.2 inch to 0.4 inch water gauge (50 Pa to 100 Pa) above atmospheric pressure, is introduced to prevent air ingress into the furnace through the roof ports and to exclude nitrogen and oxygen from the chemical process in the furnace.

As will be described in detail later, when electrical power is provided from the power supply 120 to the cathode electrode and the anode electrode and the cathode electrode is moved to its desired position with respect to the anode, a plasma arc is produced at the tip of the cathode electrode to initiate an exothermic reaction of the mix 14 within the chamber. This action results in the production of molten low carbon ferrochrome metal 10 in a bath at the bottom (e.g., the hearth) of the chamber 102, with lower density molten slag 12 floating on top of the higher density molten low carbon ferrochrome 10. The function of the plasma “electrical arc” is to control furnace and slag temperature to desired ranges, e.g., 1,660″8 C to 1850″8 C, to maintain a suitably fluid slag layer into which the reagents or feed mix materials are injected and reacting.

In accordance with one preferred aspect of this invention a controlled and controllable constant DC output power is provided from the power supply 120 to the electrically isolated DC arc graphite electrode 114 to initiate and maintain a plasma arc to supplement the exothermic heat generated from the chemical reaction in the chamber to maintain the molten metal and slag material bath in the chamber. The length of the arc below the tip of the DC graphite cathode electrode with respect to the molten slag and mixed feed materials introduced by injection into the furnace, is established until a desired electrical resistance is established to maintain the molten material bath in the chamber, with the electrical resistance being the sum of the resistance of the open DC plasma arc above the molten slag material bath, and the resistance of the plasma arc in the molten slag and, to a lesser degree, metal materials bath. The molten material bath is stirred, with the stirring resulting from the aluminothermic reaction, the current flowing through the molten material bath producing joule heating coupled with a magnetic effect of current flow through the molten bath to cause a local ripple effect or stirring motion in the molten material bath. This stirring action is illustrated in FIG. 8 and will be described later. The Argon gas atmosphere maintained inside the furnace free board (i.e., the open space inside the furnace above the molten slag) ensures that the aluminum reagent does not react with gaseous nitrogen and oxygen before entering the slag layer and that chromium oxide in any process reactions generated fume from the furnace is not oxidized to hexavalent chromium form.

As best seen in FIG. 7, the DC plasma arc furnace 100 also has an exit off-gas port 170 through which Argon gas and other process reactions generated off-gas fumes and dust particles produced within the furnace during operation of the furnace exit from the furnace. This dust is collected in the gas cleaning system 30, from where the dust retained in the gas cleaning system is returned to the chromite ore dryer 29 to be reintroduced or recycled to the dried chromite ore feed bin 74 from where it is transferred to the furnace dried chromite ore feed silo 50.

In accordance with one preferred aspect of the system of this invention, includes a single graphite plasma transferred arc cathode electrode 114 and a single conductive hearth and anode, which as stated above is made up of a conductive refractory annulus 126 and an electrical return water-cooled copper anode 130. As clearly shown in FIG. 6 the conductive refractory annulus is embedded in the center of the hearth refractory and is installed onto a water-cooled external copper anode 130.

The cathode electrode extends through the top or refractory roof dome 110 of the furnace and into to the chamber 102. The cathode electrode 114 is positioned in the center of the roof refractory dome 110 to ensure electrical isolation with the rest of the furnace roof. The cathode electrode 114 is powered from a controlled AC power transformer and DC rectifier, collectively known as a “rectiformer” or furnace power supply 120.

The cathode electrode 114 may be formed of graphite and as mentioned earlier is a cylindrical member. In particular, in accordance with one preferred aspect of this invention it is made up of plural circular sections with threaded nipple connections so that additional electrode sections may be joined to the graphite electrode section(s) already installed and used in the furnace as the tip of the graphite section in use are consumed due to the extremely high temperature of the plasma electric arc.

Cooling water for the shell 146 and roof 108 of the furnace is provided from a furnace water cooling device, such as an air-cooled heat exchanger or cooling tower (not shown). The external or copper dish return electrical anode 130 is positioned at the bottom of the furnace underneath the conductive hearth refractories, which forms the cradle or bath in which the molten low carbon ferrochrome metal 10 and the molten slag 12 are produced and accumulated.

As is known, slag formulations, with an aggressive composition, have a severe detrimental effect on refractory materials making up an arc furnace. Even under the condition of “static” slag and moderate temperature, erosion rates are severe and catastrophic failure may soon occur. The combination of the aggressive slag and the stirring of the slag, at elevated temperature, through the exit (e.g., outlet taphole) of the furnace create an extremely difficult challenge to the refractory lining design and selected refractory materials. This is typically resolved by using a replaceable taphole refractory block or preferentially by using a water-cooled slag refractory lined discharge external “mickey” block. The disadvantages of the water-cooled discharge block are two-fold. First, it is difficult to start the flow of slag even with a substantial “head” of liquid slag inside the furnace. Second, it is difficult to maintain an adequate flow of slag as the “head” of slag in the furnace diminishes.

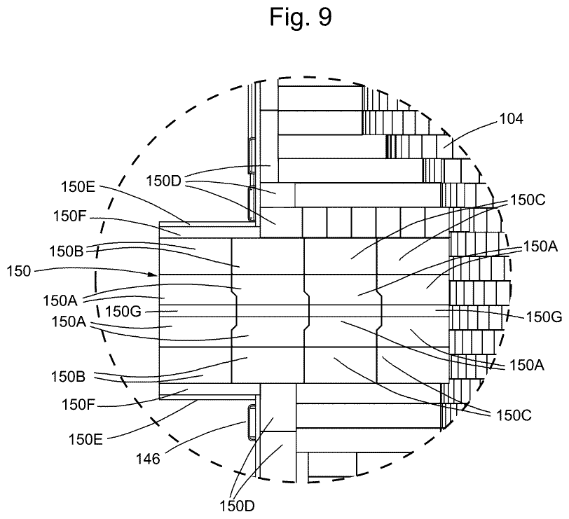

In accordance with one preferred aspect of the method of this invention, the molten low carbon ferrochrome and the molten slag are extracted intermittently and continuously, respectively, through their respective slag tapholes, 148 and 150. The construction of the upper or slag outlet taphole 150 is best seen in FIG. 9 and basically comprises an assembly of Magnesium Oxide-Chrome Oxide tap-blocks 150A, an assembly of High-Alumina surround bricks 150B, an assembly of Magnesium Oxide Chrome Oxide surround bricks 150C, a plurality of graphite tiles 150D, an external steel casing 150E, and a ramming material interface 150F. The Magnesium Oxide-Chrome Oxide tap-blocks 150A include a central passageway 105G through which the molten slag flows to exit the taphole 150. The surround bricks 150B and 150C surround the tap-blocks 150, with the surround blocks being located contiguous with the outlet of the taphole 150. The outlet of the taphole 150 includes the external steel casing 150E, which is water-cooled. A thermally insulating, e.g., 1,600″8 C, ramming material is provided in the interface between the taphole casing 150E and the surround brick 150B to ensure good contact between the refractory surround bricks and the steel casing. The surround bricks are thermally conductive to allow heat to dissipate from the tap-blocks 150. The graphite tiles are provided for increased heat transfer between the furnace housing or body 104 in the critical cooling areas and the furnace steel shell.

The operation of the slag taphole assembly enables the slag 12 to flow continuously from the furnace 100 to maintain a constant thickness of molten slag within the furnace.

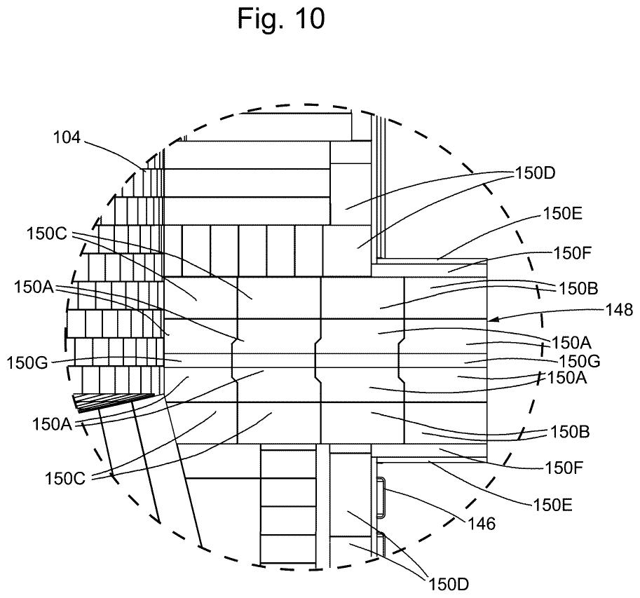

The construction of the lower or low carbon ferrochrome outlet taphole 148 is best seen in FIG. 10 and is identical in construction to the slag outlet taphole 150. Thus, in the interest of brevity the common components making up the low carbon ferrochrome outlet tap hole and the slag taphole will be given the same reference numbers and the details of their construction, arrangement and function will not be reiterated.

By operating the furnace with a nitrogen and oxygen-free free board atmosphere, the aluminum does not react prior to entering the molten slag layer. The exothermic reactions of the aluminum with the chromite ore in the slag layer thereby heat the slag and metal layers. The purpose of the plasma heating is to maintain the temperature of the slag layer formed from the slag making oxides in the chromite spinel and the lime flux added in the feed mixture. An additional purpose of the DC plasma heating is to maintain the temperature of the slag layer to ensure a sufficiently fluid or low viscosity slag so that the slag flows readily and continuously through the slag taphole 150, thus preventing solidification of the slag in the slag taphole. The heat from the DC plasma arc also offset the heat losses through the furnace refractory lining and water-cooling systems that are an integral part of the DC plasma furnace.

As best seen in the illustration of FIG. 8 electrical current flowing from the plasma electric arc through the molten slag bath provides “Joule heating” from the resistance between the electrical current flowing through the molten resistive slag causing an increase in temperature in the immediate local area of slag underneath the electrode. This increase in temperature due to Joule heating decreases the viscosity of the slag in the local area underneath the electrode. This effect combined with the induced magnetic field or “Corkscrew” effect causes a rotational effect on the volume of lower viscosity molten slag in the immediate local area underneath the electrode or in the arc attachment zone. This continuously rotating volume of molten slag contains reacting and reduced metallic particles of aluminum and ferrochrome metal (metallic “prills”). These are fine metallic particles of formed low carbon ferrochrome which have not yet settled to the metal bath below the slag, and which are still suspended in the molten slag—the lower the slag viscosity the lower the concentration of prills in the molten slag—prills settle (migrate) faster to the metal bath—the higher metal yield and chrome recovery.

Voltage of the arc will vary depending upon the total resistance of the electrical path consisting of the arc length in the Argon gas atmosphere above the molten slag melt (free board), slag layer resistance and the metal bath layer resistance. It should be noted that the slag layer is also flowing towards and out of the furnace through the slag taphole 150 causing continual movement of the slag.

Turning now to FIG. 1B, the detailed paths of the gases/dust and other particulate through the components of the system 20 is shown by the arrow-headed lines in FIG. 1B and will now be described. Thus, as will be seen, the recycled Argon gas, which is used to inject the feed mix materials into the DC plasma arc furnace, is provided from recycled Argon tank 32B. Once the feed mix materials are delivered to the furnace molten slag layer, the dust loaded Argon gas is returned through the furnace gaseous free board, furnace roof off-gas port to the furnace, gas scrubber 44, which is a water-cooled off-gas duct and dry gas cooling and cleaning system. That system is used to remove solid materials and other gaseous phases from the ejected furnace off-gas. One particular gas scrubber 44 is designed by and available from Lange USA. The cleaned furnace off-gas from the gas scrubber is then recycled to the Recycled Argon Tank 32B, for reuse as feed mix injection gas in the next cycle of feed mix materials injection into the DC plasma arc furnace. The recycled Argon gas is also used to create air/gas seals to the furnace, for example the electrode seal, i.e., the seal of any gaps or spaces between the outer surface of the electrode 114 and the components of the furnace through which the electrode extends. Clean Argon gas from the Main Argon Supply Tank 32A is provided as purge gas to various locations, e.g., the feed material silos 50, 52, 56 and 58, and to top-up gas to the Recycled Argon Supply Tank 32B to make up for Argon gas losses from the closed Recycled Argon Supply Tank and Feed Mix Injection circuit.

It must be pointed out at this juncture that the construction of the furnace electrode and associated electrical components, as well as the mode of operation of the cathode electrode to achieve advantageous stirring is not limited to the production of low carbon ferrochrome metal in a DC plasma arc furnace. Thus, the construction and method of use of the cathode electrode for stirring slag and metal layers in a DC plasma arc furnace can be used to advantageously produce various other types of metals and alloys in a DC plasma arc furnace.

As mentioned earlier the electrically isolated DC transferred arc graphite electrode 114 extends vertically through the roof refractory dome 130 of the plasma furnace 100. The electrode 114 is fitted with independent height control so that the position of the electrode section above the molten slag material bath can be controlled. To that end, the furnace 100 is provided with a vertical hydraulically operated support column, incorporating a movable horizontal arm 116 that includes an electrically isolated copper clamping mechanism (not shown) for holding and altering the vertical position of the cathode electrode 114 and providing a connection clamp for the supply of electricity from the power supply 120 to the cathode electrode. The electrode arm, the electrode clamping mechanism and the electricity supply clamp of the support column is configured to be moved in a vertical direction to raise or lower the cathode electrode.

As also mentioned earlier the cathode electrode 114 is a cylindrical or rod-like member comprising an assembly, e.g., two to three electrode sections joined together. The raising or lower of the cathode is provided to adjust the arc length and to account for ablation and erosion of the graphite by the electrical arc from the tip of the electrode assembly to the slag bath. As also mentioned earlier, the electrode section is machined with internal and external threading at the ends so that additional graphite sections may be joined thereto from the top as the tip of the graphite electrode section closest to the slag bath is consumed due to the high temperatures of the plasma electrical arc. This feature enables continuous operation of the electrode and furnace, only with short intermittent stoppages to join new electrode sections. The additional electrode sections may be connected to the electrode assembly in use, by using a movable jib crane arrangement.

The DC plasma arc power supply 120 for the cathode electrode 114 provides a controlled and controllable constant power supply at a selected resistance setpoint, with the voltage and current being allowed to vary depending on the actual real-time and instantaneous “arc” resistance of the process, relative to the desired setpoint resistance. The “arc” resistance is the sum of the resistances in the open arc and the resistance in the molten slag bath. The direct current power supply output is connected as a single negative common point to the electrical supply electrode and a single positive common point to the electrical return copper anode. The external electrical return copper anode 130 as discussed above may be a water-cooled copper dish that is installed at the bottom of the furnace underneath the conductive hearth refractory, which is also electrically conducting, to make contact with the metal layer, e.g., the molten ferrochrome metal, of the bath and thereby complete the electrical circuit through the metal and slag layers of the bath to the graphite cathode electrode. The electrical return copper anode terminations to the water-cooled copper dish, as well as the copper dish itself, are water-cooled to prevent electrical resistance overheating.

Initiating the plasma arc can be carried out in a specific way in accordance with the method of this invention. The furnace is started up, i.e., energizing the power supply 120 and then lowering the cathode electrode 114 into the furnace's chamber 102 to contact what can be called the hearth electrical return anode. That anode is formed by a layer of low carbon ferrochrome metal 10 in contact or covering the electrical return conductive hearth refractory 126 and the return copper anode 130. To ensure that there will be a layer of low carbon ferrochrome metal in contact or covering the hearth electrical return anode prior to the initial start-up, pieces of low carbon ferrochrome metal can be placed in the bottom of the furnace so that the plasma arc will form a molten layer of metal in contact with the top portion of the electrically conductive refractory and electrical return copper anode. One of the ways of initiating the plasma arc entails selecting a “Setpoint Power” value together with “Plasma On” setting on the plasma power supply 120 also referred to as a “closed circuit”—only electrical current flowing. Ignition of the arc is then achieved by raising the electrode until a satisfactory power input is established, which is also referred to as an “open circuit”—electrical current flow and voltage potential is established between the two open ends.

The feed materials of the mix 14 are introduced into the furnace chamber 102 through the furnace feed mix materials injection ports 162, of which there are four, as best seen in FIG. 8. As can be seen those ports are in the water-cooled refractory-lined roof panels 108 and are arranged on the outside of the roof refractory dome 110.

As best seen in FIG. 1A, the low carbon ferrochromium metal 10 is intermittently tapped from the furnace directly onto the hot metal launder 34 and subsequently into a hot metal transfer tundish (not shown) into the metal ingot caster 36. At the completion of tapping the low carbon ferrochromium metal from the furnace, the low carbon ferrochromium metal taphole 148 is plugged with a refractory mixture or taphole clay of composition designed for this purpose.

The covered hot metal launder 34 is a conventional device (e.g., like that available from Economy Industrial, LLC) and is configured to receive the molten low carbon ferrochromium metal onto it directly from the furnace metal taphole 148. The molten metal is introduced from the launder into a transfer tundish from where it is introduced without splashing into the metal ingot caster 36. The metal ingot caster 36 is a conventional ingot casting machine (e.g., like that available from Economy Industrial, LLC). It basically comprises a plurality of cast iron or steel alloy molds 36A on a continuous belt conveyor 36B and is configured to collect the molten low carbon ferrochrome into the molds 36A on the conveyor 36B to form respective low carbon ferrochromium metal ingots and quench those ingots with water from a water source (e.g., spray) 36C, whereupon the ingots solidify. The solidified ingots drop into the metal ingot crusher 38 receiving bin (not shown) at the discharge end of the caster, which is then transferred to the crusher, where the contents are charged from the receiving bin into the metal ingot crusher 38. That metal ingot crusher includes at least one movable jaw 38A which crushes the ingots to form crushed coarse pieces or smaller particles which are discharged onto a screen 40. The metal ingot crusher 38 is a conventional apparatus (e.g., like the Pennsylvania Crusher double toggle jaw crusher available from TerraSource Global). The crushed low carbon ferrochromium materials, which are of a specific predetermined size, e.g., approximately above 6 mm, form the final low carbon ferrochromium metal product of this invention, i.e., the ferrochrome product. That product can be charged to a product collecting bin (not shown) which is a conventional fabricated device and is configured to hold the screened ferrochrome product until this is desired to be dispensed either as large batches onto trucks or small batches into bags which may be transported to a steel mill or foundry, depending upon the specific end use for the low carbon ferrochrome metal product.

The crushed particles of low carbon ferrochrome exiting the metal ingot crusher 38, which are smaller in size than 6 mm, are hereinafter referred to as “fines”. The fines or screened undersize materials are discharged from the screen 40 into the recycling bin 42 from where they are reintroduced into the ingot molds 36A prior to addition of the next molten low carbon ferrochrome, whereupon they mix with the molten low carbon ferrochrome that is subsequently introduced therein from the hot metal launder 34. The fines or screened undersize materials are discharged from the screen 40 into the recycling bin 42 from where they are reintroduced into the crusher 38.

It should be noted that while the use of the fines in this manner is preferred, it is also contemplated that the fines from the recycling bin could be recycled with the recycled materials 56 of the feed materials to the blender 22 for mixing with the other feed materials for introduction into the furnace 28. In such a case, the fines when introduced into the furnace, drop through the molten slag and into the molten ferrochrome, where fines melt into the molten ferrochrome. In either case the fines are recaptured in the ferrochrome product. Moreover, it is also contemplated that the fines may be introduced into the ingot molds 36A whereupon they mix with the molten low carbon ferrochrome that is introduced therein from the hot metal launder 34. That action may minimize the fines load to the crusher 38 when the system 20 is operating at full capacity.

While the ferrochrome product is preferably formed by use of the ingot molds 36 and the metal ingot crusher 38 as just described, it is contemplated that it can be produced by other means, e.g., by granulating a stream of molten ferrochrome metal in water in a ferrochrome granulation tank (not shown) and associated dryer (not shown). One such granulating system is available from UHT, Kista, Sweden. In such a case, the molten low carbon ferrochrome is carried by the hot metal launder 34 to the ferrochrome granulation tank (not shown). The ferrochrome granulation tank is configured to break the molten low carbon ferrochrome into fine droplets and to rapidly quench those droplets with water provided from an inlet water source, whereupon the droplets solidify. The solidified droplets are transported from the ferrochrome granulation tank onto a screen (not shown, but similar to the described screen 40). Those ferrochrome granules which are greater in size than 6 mm are carried from the screen (not shown) for introduction into a dryer (not shown), whereupon the heat provided within the dryer removes any residual water on those granules resulting from their quenching in the ferrochrome granulation tank. The dryer is a conventional device (e.g., like that available from UHT, Kista, Sweden.). The dried low carbon ferrochrome granules that exit the dryer form the ferrochrome product granules, which are carried to the collecting bin (not shown, but similar to the bin described earlier).

A site or plant constructed in accordance with the exemplary system 20 for carrying out the process of this invention is preferably completely self-contained or enclosed in a building. In particular, the only materials produced from the process of this invention that exit the plant are the heretofore mentioned two products, namely, the ferrochrome product and the slag product. Everything else, e.g., the dust from the furnace (which may contain chromium oxides), and any spillage of materials within the material handling portion of the system 20 are provided back to the blender 22 as the recycled materials 56. The Argon gas is cleaned and recirculated to be used again in the feed mix materials injection system. These actions render the method of this invention not only economic, but environmentally protective.

As mentioned above, it is from the upper outlet port or taphole 150 of the furnace 100 that the molten slag 12 produced by the method of this invention flows when that taphole is opened. In particular, the molten slag is provided into an inlet port of the slag quench conveyor (wet quench process) 46. The slag quench conveyor 46 is a conventional device (e.g., like that available from General Kinematics) and is configured to break the molten slag into “popcorn-sized” particles and droplets and to rapidly quench those droplets with water provided from an inlet water source (not shown). This action results in the formation of slag particles. This method produces slag particles of a suitable size, e.g., in the range of approximately 3 mm to 8 mm for use as an aggregate in construction or for use in the production of cement.

The slag product particles are transferred from the slag quench conveyor discharge via a series of belt conveyors and charged to the quenched slag product collecting bin or slag silo 48. The slag product in the slag product silo is then discharged as bulk loads or batches directly from the silo bottom discharge into trucks or bags.

The chemistry of the slag formed by the method/process of this invention is critical to the commercial viability of that method/process. In this regard, it is desirable to minimize the melting point of the slag while maximizing its fluidity to enable it to readily flow out of the furnace. Thus, the method of this invention entails optimizing the chemistry of the slag to enhance its fluidity at the selected operating temperature. To that end, the amount of burnt limestone added to the process is controlled based on the amount of magnesium oxide, aluminum oxide and silicon dioxide that is in the chromite mineral or chromite ore. For example, if the chromite mineral is high in silica, then the process will require the addition of more burnt limestone. If the chromite ore is low in silica, then the process will use less burnt limestone. The melting point of the chromite minerals can be from 1,700° C. to 2000° C. The method/process of this invention entails utilizing the lowest possible temperature for the melting point which will result in the maximum slag fluidity and maximum chromium recovery. The composition of the slag will not have any effect on the exothermic reaction reducing the chromite ore to the low carbon ferrochrome metal but will influence the fluidity of the slag produced.

The chromium oxide and the iron oxides in the chromite ore are in the form of the mineral spinel. The exothermic reaction under stoichiometric conditions to reduce the oxygen out of the chromium oxide and the iron oxides may not produce enough heat to ensure that the whole mass of the feed materials becomes liquid. To ensure the reduction of chromium oxide and iron oxides is optimized, thermochemistry calculations (e.g., with Metso-Outotec's developed HSC chemical, therrodynarnic, and mineral processing simulation software package and CRCT's developed FactSage chemical and thermodynamic computer software package) are used to predict the optimum ratios of the feed materials. In addition, the heat provided by the DC plasma electric arc furnace ensures that there is sufficient heat to smelt the entire mass of feed materials into a superheated bath of slag and molten metal.

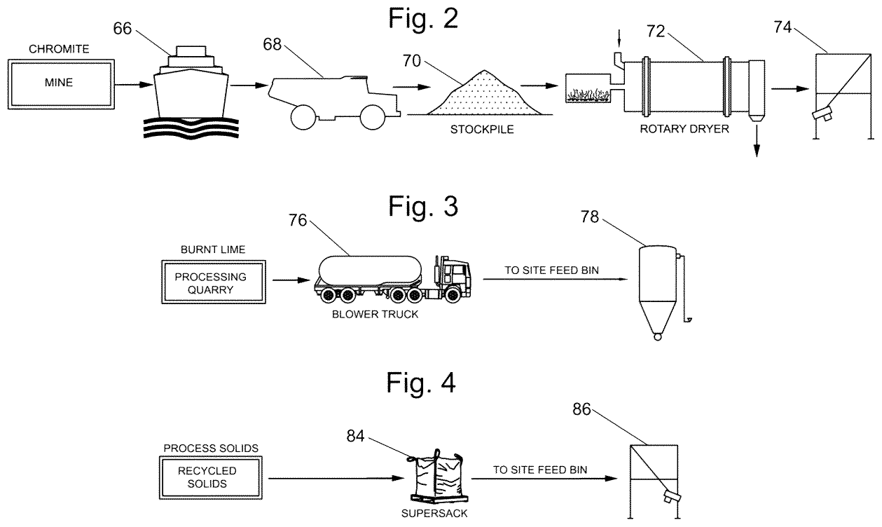

The chromite ore feed material 50 is stored in a feed bin on the site or plant at which the system 20 is located, and is provided from its initial source, e.g., a mine, as shown in FIG. 2. Thus, as can be seen in FIG. 2, the ore from a mine is transported by ship 66 (assuming that the mine is located across some large body of water requiring sea freight transportation) from where it is carried by truck 68 to a stockpile 70 at the site or plant for use in the system 20. The chromite ore is dried in a conventional rotary kiln dryer 72 and the dried chromite ore is then stored in a site located feed bin 74 ready for use in the process.

The burnt lime feed material 52 is also stored in a feed bin on the site or plant at which the system 20 is located, and is provided from its initial source, e.g., a processing quarry, as shown in FIG. 3. Thus, as can be seen in FIG. 3, the burnt lime from a processing quarry is transported by blower truck 76 to a site storage feed bin 78 at the site or plant of the system 20 ready for use.

The process solids from the cleaned furnace off-gas stream are also stored in a feed bin on the site or plant at which the system 20 is located, and are provided from the furnace off-gas scrubber 44, from where it can either be stored in a dust recycle bin 30B or as shown in FIG. 2 recycled directly to the rotary kiln dryer 72, and from the rotary kiln dryer to the recycling bin 86, via super sack 84, to the site feed bin 56 at the site or plant of the system 20 ready for use.

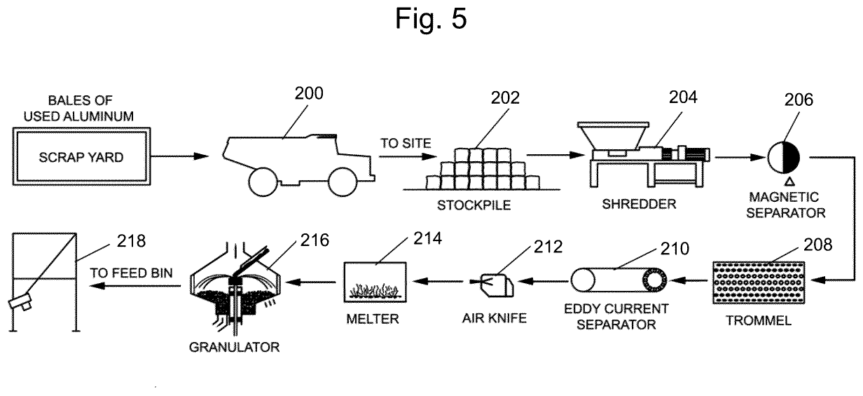

The aluminum granules 58 are stored on the site or plant at which the system 20 is located, and as shown in FIG. 1A. As best seen in FIG. 5, the aluminum granules are provided from a scrap yard in the form of bales of scrap aluminum. The bales are transported by truck 200 to the site where they are stored in a stockpile 202. From the stockpile the bales are broken up and fed to a conventional shredder 204 to release non-aluminum solid matter. The non-aluminum solid matter is then separated and cleaned via the shredder. The shredded scrap aluminum is provided to a conventional magnetic separator 206 to remove any magnetic particles. From there the scrap aluminum is provided to a conventional trommel 208 including a rotating screen to remove any dirt, liquids, and water. From there the aluminum scrap is passed through an eddy current separator 210 to remove any non-ferrous metals, wood and other trash. From there the aluminum scrap is provided to a conventional air knife 212 to remove any residual water, plastic, and paper. The cleaned scrap aluminum is then provided to a conventional melter 214 where it is melted in air to produce molten scrap aluminum. The molten scrap aluminum is then fed to a conventional granulator 216 where the molten aluminum is discharged onto a rotating perforated graphite cup to form molten aluminum droplets which are cooled in air as they fall and solidify into granules. Preferably the granules are in a size range of approximately 0.1 mm and 2.0 mm. The aluminum granules are then carried to a feed bin 222 at the site or plant where the system 20 is located ready for use.

It has been determined that the moisture pick-up from a wet scrubbing gas injection/recirculation system can create downstream problems in the feed mix injection system, e.g., clogging of dispensing vessels, injector lines and lances, as that type of system is extremely sensitive to moisture in the feed mix. One potential solution to overcome that problem entails drying and calcining ore to remove moisture, making use of an ultra-low moisture content lime, and using aluminum granules having no or negligible moisture content.

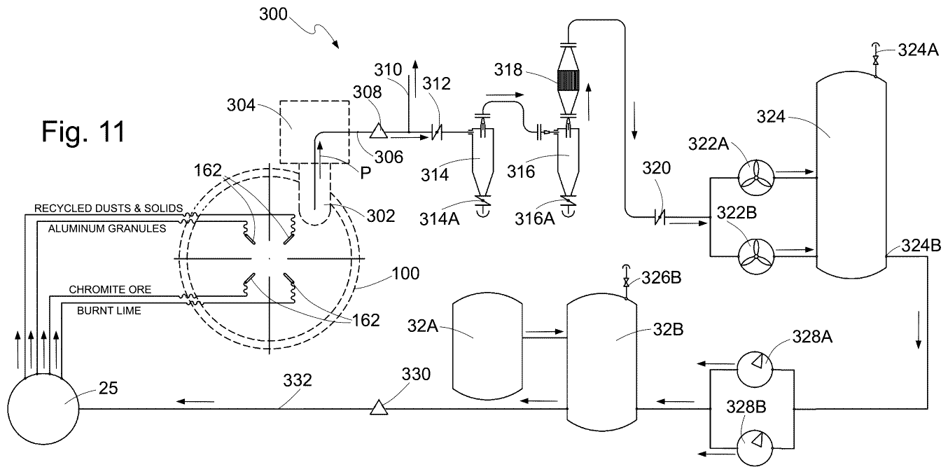

However, such a solution would be expensive to implement. To prevent issues with the injection system, while providing a cost-effective system for producing a low carbon ferrochrome or other ferroalloys, the moisture content in the recirculated gas should be kept very low, e.g., approximately <0.005 vol %. FIG. 11 shows one exemplary dry gas recirculation and recovery system 300 constructed in accordance with this invention which achieves that end. For example, that particular embodiment is capable of providing a moisture (H₂O) content in the recirculated gas of 0.001 vol %.

It should be noted at this time that while the exemplary gas recirculation and recovery system 300 of FIG. 11 is particularly suited for use in the smelting system 20 as described above, it can be used in other aluminothermic smelting systems or processes, such as those for producing FeNb, FeTi, etc., which do not generate significant process gas and which use an inert gas, such as Argon, etc., as the feed mix injection gas. Thus, a gas recirculation and recovery system of this invention could also be used in aluminothermic processes where Nitrogen is used as a carrier injection gas and should lead to significant cost savings and environmental credits, not having to vent 100% of injection gas to atmosphere. When the gas recirculation and recovery system 300 is used in a smelting system, like the system 20, to produce low carbon FeCr, recovery of the inert carrier gas (e.g., Argon) is expected to be 95% of the required process gas volume, which allows for a commercially viable process technology to be applied.

The inert gas recirculation and recovery system 300 collects the furnace off-gas (e.g., Argon and dust particulates resulting from the smelting process) from the chamber of the furnace to cool that furnace off-gas and remove the dust particulates, whereupon the cleaned Argon is recovered and reused. The system 300 basically comprises an off-gas roof duct assembly 302, a drop-out box 304, a fixed duct 306, a primary analyzer 308, a vent 310, a primary air-flow damper 312, two dust removing cyclones 314 and 316, two associated dust discharge valve systems 314A and 316A, a heat exchanger (pipe-cooler) 318, a secondary air-flow damper 320, two induced draft gas flow draw fans 322A and 322B, a buffer tank 324, two gas compressors 328A and 328B, the heretofore identified recycled Argon tank 32B, a secondary gas analyzer 330, and the heretofore identified main Argon tank 32A. As will be described in detail shortly hereafter those components are connected by associated conduits/pipes/ducts to form a gas flow path P from the chamber 102 in the furnace 100 back to the material feed injection system 25 and the chamber 102 as indicated by the arrows shown in FIG. 11.

The system 300 is configured for fully automated operation, independent of operating personnel and will handle the Argon carrier gas at a volume of up to 1200 Nm³/h, which after being used for the injection of the solid material mix into the arc furnace, is recycled and reused to allow for the necessary continuous injection process. This results in lower process costs, e.g., saving of up to 80% of gas expense at any time.

As shown in FIG. 11, the material feed injection system 25 receives the feed mix carrier gas (i.e., a mixture of Argon gas that has been recycled by the system 300 and fresh Argon gas from the Main Argon Supply Tank 32A) to inject the feed mix (i.e., the burnt lime, the chromite ore, the aluminum granules and the recycled dusts and solids) into the furnace 100 to smelt the feed mix to produce the low carbon ferrochrome. The feed injection system 25 receives the carrier gas for the feed mix from the Recycled Argon Tank 32B. The Recycled Argon Tank is itself topped-up with fresh Argon gas from the Main Argon Supply Tank 32A, thereby producing what will be referred to hereinafter as recycled Argon gas for use by the system 20.

The off-gas roof duct 302 is preferably a water-cooled assembly which serves to carry the off-gas produced during the smelting operation from the furnace's chamber 102 to the furnace off-gas drop-out box 304 and is designed and configured to allow for a reliable working process at all times. To that end, the roof duct 302 is designed to be air-tight and does not allow for any atmospheric air ingress into the sealed recirculating gas system during normal working operation. It is a pipe-to-pipe design composed of steel and consists of various lengths and bends and includes all necessary water inlets/outlets. The roof duct 302 is designed to reduce the temperature of the off-gas during processing by approximately 650 degrees C. to 1200 degrees C. It operates at an operating pressure of approximately 3-4 bar, at an operating temperature of maximum +50° C., and a test pressure of approximately 10 bar.

The drop-out box 304 is a water-cooled device which is connected downstream of the roof duct and serves to slow down the velocity of the off-gas from the roof duct. It also cools the off-gas due to gas expansion in the bigger volume that it provides downstream of the roof-duct. The drop-out box is also configured to remove dust particles, e.g., coarser particles greater than approximately 45 microns, from the off-gas.

The fixed duct 306, is a water-cooled duct which is connected downstream of the drop-out box. The drop-out box 304 and fixed duct 306 further cool the off-gas flowing therethrough to, e.g., approximately 300 degrees C.

The gas analyzer 308 is a conventional on-line device, e.g., sold by Drager Online Gas Analyzers under the model designation Polytron 8700 IR Gas, and is connected downstream of the fixed duct. The analyzer measures H₂, CO, and H₂O with Argon gas then being the balance to 100 volume percent in the off-gas flowing through the fixed duct in order to determine the specific furnace off-gas composition.

The system 300 includes an emergency ventilation valve system, e.g., a valve forming the vent 310, that allows for venting of the gas duct 306 if the downstream gas system is off-line or in case of any blockage, and/or other reasons (e.g., incorrect gas composition that cannot be recycled). To that end, the vent 310 is located in the flow path downstream (e.g., at the end) of the off-gas duct 306 and upstream of the first dust removing cyclone. The valve's release is automatic in case of any disturbance within the system, whereupon the Argon is temporarily released (vented) to ambient atmosphere, e.g., the air outside the factory or to another gas cleaning system, e.g., baghouse 30A or other building in which the arc furnace 100 is located, until the furnace can be switched off.

The two dampers 312 and 320 are provided in the system 300 for furnace gas-flow regulation to assure optimum process conditions with regards to flow, gas-particle separation, and maximum heat extraction. In particular, the first air-flow damper 312 is connected downstream of the analyzer 306 and the vent 310. The damper 312 is a Type 1, heat-resistant, proportional, pneumatic (dry air) controlled, damper, which allows any predetermined percentage of gas flow downstream of damper. The damper 312 controls the furnace freeboard gas pressure by restricting gas flow downstream. When the damper 312 is fully closed the off-gas from the gas duct 306 is diverted to the vent 310, whereupon the off-gas vents out of that vent to the ambient atmosphere or to another gas cleaning system, e.g., baghouse 30A. The damper 312 is made of special steel, e.g., 304L Stainless Steel, and is heat resistant. One particularly suitable damper is that sold by Flo-Dyne under the model designation Pulsation Damper API674.

The off-gas passes through the damper 312 to a dust removing cyclone system which is located downstream of the damper and serves to cool the off-gas further, e.g., reduce its temperature by approximately 350 degrees C., and to remove dust particulates within the range of less than approximately 45 microns to greater than approximately 15 microns from the off-gas. That cyclone system includes two sequentially located cyclones 314 and 316, whereas cyclone 314 is water-cooled. The first cyclone 314 is a Type 1 cyclone and the second cyclone 316 is a Type 2 cyclone. The cyclone 314 serves to remove the coarser particles, with the cyclone 316 removing the finer particles. To that end, the cyclone 314 includes a dust discharge valve system 314A for collecting and dispensing the coarser particles from the cyclone 314. Those coarser particles are then provided to a dedicated dust storage area (not shown). The cyclone 316 is air-cooled and is located downstream of the water-cooled cyclone 314 and receives the off-gas minus the coarser particles from the cyclone 314. The cyclone 316 also includes a dust discharge valve system 316A for collecting and dispensing the finer particles from the off-gas provided to it. Those finer particles are provided to a dedicated dust storage area (not shown). Both cyclones 314 and 316 are made from special steel e.g., 304L Stainless Steel.

The heat exchanger 318 is a water-cooled pipe cooler made from copper-steel and of special design, e.g., 304L Stainless Steel. It is located downstream of the cyclone 316 to receive the off-gas from the cyclone and to reduce the temperature of the off-gas significantly, e.g., to approximately 70 degrees C. The cooled off-gas from the heat exchanger 318 is provided to the second damper 320.

The second damper 320 is a Type 2 damper and is located very close to the end of the system 300, just before draw fans 322A and 322B. The damper 320 is a proportional, pneumatic (dry air) controlled damper, which allows any predetermined percentage of gas flow downstream of damper. In particular, the damper 320 controls the pressure drop over the cyclones 314 and 316 and the heat exchanger 318. Moreover, it completely shuts off gas flow downstream and enables gas to vent to atmosphere via the vent 310 or another gas handling and cleaning system, e.g., baghouse 30A, as will be described later. The installation of the damper 320 at the above-described location ensures additional regulation capabilities for an improved working process. One particularly suitable damper 320 is sold by Flo-Dyne under the model designation Pulsation Damper API674.

The two draw fans 322A and 322B are provided to draft the off-gas from the components upstream of them and to provide the cooled and cleaned off-gas to the buffer tank 324 to support optimum gas-flow conditions at all times. The draw fans are conventional devices, such as those sold by Pimasonics under the model designation PAS350, and are eighteen inches in diameter, with a fan speed of approximately 2045 RPM, at a CFM of up to 4000. The fan 322A constitutes the operating fan of the system 300, with the fan 322B being a stand-by fan for use if the fan 322A is inoperative.

The buffer tank 324 is the tank for collecting the Argon gas which is being recycled by the system 300. The buffer tank is a non-pressurized tank of suitable size, e.g., a diameter of approximately 480 cm, a height of approximately 1150 cm, a volume of approximately 210 cubic meters. Inasmuch as the tank 324 is non-pressurized, i.e., is at atmospheric pressure, the gas entering the collection tank from the draw fans will settle down in the tank due to its weight. The buffer tank 324 has a vent 324A, which is used to vent furnace gas (approximately 200 Nm³/h) to allow “space” for fresh (or clean) Argon gas, which is added to the Recycled Argon Supply Tank 32B, as will be described later. All other gaseous materials (e.g., air, H₂, CO, etc.) will rise above the Argon gas and can be vented to ambient atmosphere, if necessary, through a vent 324A. The buffer tank 324 includes an outlet 324B at the bottom thereof and through which the Argon gas is removed and provided to the two gas compressors 328A and 328B. The buffer tank 324 is operated at atmospheric pressure and at approximately 60 degrees C., whereupon the Argon gas is cool, clean, and dry at this stage.

The two gas compressors 328A and 328B are screw-type compressors and are provided for the compression of the recycled Argon from the buffer tank 324 to approximately 6 bar for introduction into the Recycled Argon Supply Tank 32B. Each of the compressors is a custom design of suitable size and functionality to produce a gas which meets the process requirements (e.g., less than 70 degrees C., oil-free, and dry). The compressors are identical, with the compressor 328A serving as the operating compressor and the compressor 328B serving as a standby unit. The compressors include non-return valves which are not shown in FIG. 11 in the interest of drawing simplicity. The compressor design allows for RPM control and includes water-cooling capabilities. After compression the cooled Argon gas is stored in an intermediate pressure tank, i.e., the heretofore identified Recycled Argon Supply Tank 32B, so that the recycled Argon gas is ready for re-use. The tank 32B is of a suitable size, e.g., a diameter of approximately 230 cm, a height of approximately 690 cm, a volume of approximately 29 cubic meters. The pressure within the tank 32B is approximately 90 PSI. The recycled Argon gas is configured to be supplied from the Recycle Argon Supply Tank 32B back into the system via a pipeline system 332 which is connected to the material feed injection system 25.

The gas analyzer 330 located in the gas line 332 to the feed injection system 25 to provide final gas composition of the gas going to the feed injection system, post fresh Argon gas injection from the Main Argon Supply Tank 32A into the Recycle Argon Supply Tank 32B.

It should be noted that when the preferred embodiment of the inert gas (e.g., Argon) recirculation and recovery system 300 of FIG. 11 used in a system 20 like shown in FIGS. 1A and 1i, the heretofore identified wet “scrubber” 44 is not used. Rather, the wet scrubber 44 is replaced by the heretofore identified dry duct removal dropout box 304 and the dust-removing cyclone apparatus 314 and 316. Those components, in combination and in their entirety, make up what can be deemed a “dry” dust removal scrubber or apparatus.

The operation of the system 300 will be described momentarily. Before doing so it should be noted that the system 20 is configured for automatic operation. Thus, it includes a computerized controller (not shown) which controls the operation of the various components of the systems 20 and 300.

At start-up of the system 20 the furnace 100 is in its horizontal (non-tilted) position with all the furnace's hatches closed and its roof seals 162 secured. Start-up Argon gas (99.998 volume percent Argon) from the main Argon supply tank 32A (which acts as a “top-up” tank) is introduced to the recycled Argon tank 32B. In accordance with one preferred aspect of the method, the pressure within the tank 32A is within the range of approximately 6.0 bar to approximately 6.8 bar. The pressure within the tank 32B is within the range of approximately 5.5 bar to approximately 6.0 bar). At this time the non-return valves to the compressors 328A and 328B are closed. The start-up Argon gas is introduced from the tank 32B to the vessels 50, 52, 56, and 58, from whence the start-up Argon gas is injected to the furnace freeboard 102. The pressure at the furnace freeboard is approximately 1.0 bar and is established by the vent 310 and the damper 312. Moreover, the gas pressure in the furnace freeboard is maintained throughout downstream components of the path P of system 300 to the buffer tank 324 by the vent 310 and damper 312 until the gas analyzer 308 indicates 95-98 volume percent Argon. The induced draft fan 322A (or if called upon the standby draft fan 322B) drafts or draws the Argon gas from the furnace freeboard through the downstream components of the system 300 to the buffer tank 324 at the approximately 1.0 bar pressure. When the buffer tank 324 is approximately 80% full, the compressor 328A (or if called upon the standby compressor 328B) is started by the controller to introduce the Argon gas to the recycled Argon tank 32B. The start-up Argon gas from the Main Argon tank 32A is gradually reduced as the Recycled Argon Tank 32B is filling up to approximately an 80% level. The system 300 is now filled with start-up Argon gas at approximately 99.998% Argon by volume and circulation flow rates and pressures are maintained. In accordance with one preferred aspect of the method of this invention nominal start-up Argon gas volume flow rate is 960 Nm³/h at a power setpoint of 7 MW

The system 300 is now ready for normal operation (i.e., power on and feed on). To that end once power is on, the feed injection vessels 50, 52, 56, and 58 introduce the feed mix to the furnace 100 in accordance with required solids feed rate and associated gas injection volume flow rate as established by the controller. Furnace reactions start to produce the furnace off-gas, which starts to dilute the start-up Argon gas composition diluting due to other gases forming during the smelting operation. Once the furnace off-gas composition reaches 96-97 percent Argon by volume, the off-gas is vented via vent 310 and/or vent 324A under the control of the controller, and Argon top-up gas (at 99.998 volume percent Argon) is introduced to the Recycled Argon Tank 32B. Hydrogen (H₂) is produced from the smelting operation of the furnace. The off-gas composition is measured continuously by the gas analyzer 208 under control of the controller to maintain the H₂ level below 3% by volume in the recirculating off-gas composition. Once steady state operation is reached, the nominal Argon top-up volume flow rate is expected to be approximately 206 Nm³/h at approximately 130 SCFM at a power setpoint of approximately 7 MW.

As should be appreciated by those skilled in the art during steady state operation of the system 20 the pressurized off-gas from the pressurized tank (i.e., the Recycled Argon Tank 32B) comprises furnace off-gas from the upstream furnace off-gas handling system after it had been cooled and cleaned in a previous gas cycle in addition to fresh top-up Argon gas from the Main Argon Supply Tank 32A. The fresh Argon is introduced into the Recycled Argon Tank 32B to form what can be considered the “new” feed mix carrier gas going back to the feeder system and the arc furnace.

During steady state operation the furnace off-gas dust particulates are intermittently removed from the dropout box 304 and dust removal valves 314A and 316A of the cyclones 314 and 316, respectively, under the control of the controller. The furnace off-gas dust is expected to be approximately 75 kg/h at the power setpoint of 7 MW. The off-gas volume flow rate is maintained in the system 300 when the power is off, and the feed injection is off.

The shutdown of the system 300 will now be described. That action is accomplished as follows. The compressor 328A or 328B (as the case may be) is stopped and the non-return valve from the Recycled Argon Tank 32B to the compressor is closed under the control of the controller. At the same time a shut off valve (not shown) which forms a part of the buffer tank 324 to the compressors is closed and the vent 324A is completely (100%) open under the control of the controller. Also, under the control of the controller, a shut-off valve (not shown) from the tank 32B to the feed injection system 25 and a non-return valve (not shown) from tank 32B to the compressors are closed and the feed injection system is stopped once feed lines to the furnace are cleared of solid feed materials (no injection gas being introduced to the furnace). Moreover, under the control of the controller the non-return valves from buffer tank 324 to the draft fans 322A and 322B are closed, the vent 324A is closed, the draft fans are stopped, the dampers 312 and 320 are closed and the vent 310 is fully open. Air is introduced to the furnace freeboard and remaining furnace off-gas (Ar, H₂, N2, CO) is vented to atmosphere via the vent 310. The gas analyzer 308 determines air purge stoppage, whereupon the hatches on the furnace roof are opened. Once the gas analyzer 308 indicates normal air composition to the vent 310, that vent is closed under the control of the controller.

It must be pointed out at this juncture that the systems 20 and 200 and their components as described above are merely exemplary embodiment of various systems that can be constructed in accordance with this invention to carry out the methods or processes of this invention. Moreover, the method described above is merely exemplary of various methods or processes for producing low carbon ferrochrome in accordance with this invention. Thus, for example, the system 20 may use steam in a heat exchanger to preheat Argon injection gas to reduce the smelting energy requirement in the furnace 100. Moreover, the ferrochrome fines may not be reused if such fines could be otherwise commercialized. So too, the dust particles from the DC plasma furnace off-gas stream, which are collected from the furnace off-gas cleaning and recirculating system may not be recycled to the recycling bin. Further still, other types of arc furnaces, granulation tanks and granulators, and other apparatus can be used in lieu of the exemplary furnace, metal ingot caster, metal ingot crusher, and the furnace off-gas cleaning and Argon recirculation system respectively. Other portions of the exemplary system 20 and the steps the exemplary method/process as described above can be eliminated, if desired, providing that the system and method/process makes use of aluminum granules as the exothermic source to reduce the chromium oxide and iron oxides in the chromite ore and to produce a slag which is sufficiently fluid to enable the formation of the low carbon ferrochrome metal to be carried out economically and which itself can be readily quenched into slag particles or granulated into slag granules for commercial use.

Without further elaboration the foregoing will so fully illustrate our invention that others may, by applying current or future knowledge, adopt the same for use under various conditions of service.

We claim:

1. A system for recovering ferrochrome metal or another ferroalloy in a chamber of an arc furnace using an aluminothermic smelting process, wherein the aluminothermic smelting process is carried out in the presence of an inert gas introduced into the chamber, whereupon a furnace off-gas including the inert gas and particles of dust is produced during the smelting process, said system comprising;
a main inert gas supply tank;
an off-gas duct configured to be coupled to the arc furnace, and forming an upstream component of a gas flow path from the arc furnace, whereupon the furnace off-gas is delivered by said off-gas duct into a gas flow pat;
a primary damper is located in said gas flow path downstream of said off-gas duct and is coupled to a vent in communication with the ambient atmosphere;
a dust-removing cyclone apparatus is located in said gas flow path downstream of said primary damper and is configured for cooling the furnace off-gas from said primary damper and for removing particles of dust from the furnace off-gas;
a heat exchanger is located in said gas flow path downstream of said dust-removing cyclone apparatus for further cooling the furnace off-gas from said dust-removing cyclone apparatus to produce cooled furnace off-gas;
a buffer tank having an interior at atmospheric pressure and an outlet coupled to said interior of said buffer tank is located in said gas flow path downstream of said heat exchanger for receipt of the cooled furnace off-gas from said heat exchanger;
an induced draft gas draw fan is located in said gas flow path between said heat exchanger and said buffer tank for drawing the cooled furnace off-gas from said heat exchanger and providing it into said interior of said buffer tank, whereupon the inert gas drops to a bottom portion of said interior of said buffer tank and out of said outlet;
a pressurized tank is located in said gas flow path downstream of said buffer tank, said pressurized tank having an inlet and an outlet; and
a gas compressor is located in said gas flow path between of said outlet of said buffer tank and said inlet to said pressurized tank, said gas compressor being configured for compressing the cooled furnace gas from said outlet of said buffer tank to a desired pressure to produce compressed cooled inert gas and delivering the compressed cooled inert gas to said pressurized tank, said pressurized tank being coupled to said main inert gas supply tank for receipt of inert gas from said main inert gas supply tank, whereupon said inert gas tops off said compressed cooled furnace gas in said pressurized tank to produce pressurized recycled inert gas, said pressurized tank being coupled to the furnace to deliver said pressurized recycled inert gas from said pressurized tank back to the arc furnace.

2. The system of claim 1 wherein the inert gas is Argon and wherein the system additionally comprises a source of feed materials comprising chromite ore, aluminum granules and burnt lime, said feed materials being fed into said chamber along with the Argon gas.

3. The system of claim 1 wherein said off-gas duct is water-cooled.

4. The system of claim 1 wherein said dust-removing cyclone apparatus is water-cooled.

5. The system of claim 1 wherein said primary damper is configured to control furnace freeboard pressure by restricting gas flow downstream of the furnace, and to prevent complete gas flow downstream of the furnace to said dust-removing cyclone apparatus.

6. The system of claim 1 wherein said heat exchanger is a pipe cooler.

7. The system of claim 1 wherein said gas compressor is a screw-type gas compressor.

8. The system of claim 1 wherein said buffer tank includes a pressure relief vent to the ambient atmosphere.

9. The system of claim 1 additionally comprising a primary gas analyzer located in said gas flow path between said off-gas duct and said primary damper.

10. The system of claim 8 additionally comprising a secondary gas analyzer located in the gas flow path between said pressurized tank and said furnace.

11. The system of claim 1 additionally comprising a secondary flow damper located in said flow path between said heat exchanger and said induced draft gas draw fan, said secondary flow damper being configured to control the pressure drop over the dust-removing cyclone apparatus and heat exchanger.

12. A method of recovering ferrochrome metal or another ferroalloy in a chamber of an arc furnace using an aluminothermic smelting process, wherein the aluminothermic smelting process is carried out in the presence of an inert gas introduced into the chamber along with feed materials, whereupon a furnace off-gas including the inert gas and particles of dust is produced within the chamber, said method comprising:
removing said furnace off-gas from said chamber and cooling said off-gas in an off-gas duct forming a portion of a gas flow path from said chamber of said arc furnace;
providing a first apparatus in said flow path downstream of said off-gas duct for further cooling of said furnace off-gas and removing particles of dust from said furnace off-gas to result in low particle furnace off-gas;
providing a second apparatus in said gas flow path downstream of said first apparatus for cooling the low particle furnace off-gas to produce cooled low particle furnace off-gas;
carrying said cooled low particle off-gas into an interior of a buffer tank at atmospheric pressure, whereupon said cooled low particle furnace off-gas drops to a bottom portion of said interior of said buffer tank;
removing said cooled low particle furnace off-gas from said interior of said buffer tank and compressing said cooled low particle furnace off-gas to produce pressurized low particle cooled furnace off-gas and providing said pressurized low particle cooled furnace off-gas to a pressurized tank in said gas flow path downstream of said buffer tank; and
providing said pressurized low particle cooled furnace off-gas back to the arc furnace.

13. The method of claim 12 additionally comprising providing a main inert gas supply tank holding inert gas, coupling said main inert gas supply tank to said pressurized tank to deliver said inert gas from said main inert gas supply tank to said pressurized tank, whereupon said inert gas tops off the pressurized low particle cooled furnace off-gas in said pressurized tank to produce pressurized recycled inert gas, and delivering said pressurized recycled inert gas from the pressurized tank back to said arc furnace.

14. The method of claim 12 additionally comprising providing a primary damper located in said gas flow path downstream of said off-gas duct to cause control the furnace freeboard pressure by restricting the gas flow downstream of the furnace, and to prevent complete gas flow downstream of the furnace to the dust-removing cyclone apparatus.

15. The method of claim 12 wherein said inert gas is Argon, and wherein said feed materials comprise chromite ore, aluminum granules and burnt lime.

16. The method of claim 15 wherein said feed materials are fed into said chamber with said Argon gas.

17. The method of claim 13 additionally comprising providing a primary damper located in said gas flow path downstream of said off-gas duct to cause control the furnace freeboard pressure by restricting the gas flow downstream of the furnace, and to prevent complete gas flow downstream of the furnace to the dust-removing cyclone apparatus.

18. The method of claim 13 wherein said inert gas is Argon, and wherein said feed materials comprise chromite ore, aluminum granules and burnt lime.

19. The method of claim 18 wherein said feed materials are fed into said chamber with said Argon gas.
